(19) United States
(12) Patent Application Publication
(10) Pub. No.: US 2022/0251344 A1
(43) Pub. Date: Aug. 11, 2022

(54) TIRE HAVING EXTERNAL SIDEWALLS

(71) Applicant: COMPAGNIE GENERALE DES ETABLISSEMENTS MICHELIN, Clermont-Ferrand (FR)

(72) Inventors: JEAN-LUC CABIOCH, Clermont-Ferrand (FR); STEPHANIE JULIEN, Clermont-Ferrand (FR)

(21) Appl. No.: 17/610,956

(22) PCT Filed: Apr. 28, 2020
(86) PCT No.: PCT/EP2020/061670

§ 371 Date: Nov. 12, 2021

(30) Foreign Application Priority Data
May 14, 2019 (FR) FR1904991

(51) Int. Cl. C08L 9/00; B60C 1/00

(52) U.S. Cl. CPC C08L 9/00; B60C 1/0025

(57) ABSTRACT

A tire exhibits resistance to ozone and improved mechanical properties, said tire being provided with at least one outer sidewall comprising a composition based on an elastomeric matrix comprising at least one isoprene elastomer and one polybutadiene, from 0.2 to 10 phr of at least one salt of an alkali, alkaline-earth or lanthanide metal, at least one reinforcing filler, and a crosslinking system.

The present invention relates to tyres and more particularly to tyre outer sidewalls, that is to say, by definition, to elastomeric layers located radially on the outside of the tyre, which are in contact with the ambient air.

Since a tyre has a geometry exhibiting symmetry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively. The expressions “radially”, “axially” and “circumferentially” mean “in the radial direction”, “in the axial direction” and “in the circumferential direction”, respectively. The expressions “radially inner/radially on the inside or, respectively, radially outer/radially on the outside” mean “closer to or, respectively, further away, from the axis of rotation of the tyre, in the radial direction, than”. The expressions “axially inner or, respectively, axially outer” mean “closer to or, respectively, further away from the equatorial plane of the tyre, in the axial direction, than”, the equatorial plane of the tyre being the plane perpendicular to the axis of rotation of the tyre that passes through the middle of the tread of the tyre.

It is possible to define, within the tyre, three types of regions:
the exterior radial region in contact with the ambient air, this region being essentially composed of the tread and of the outer sidewall of the tyre. An outer sidewall is an elastomeric layer positioned outside the carcass reinforcement relative to the internal cavity of the tyre, between the crown and the bead, so as to totally or partially cover the region of the carcass reinforcement extending from the crown to the bead,
the radially interior region in contact with the inflation gas, this region generally consisting of the layer airtight to the inflation gas, sometimes referred to as inner liner, and
the internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

A tyre sidewall must have many other characteristics that are sometimes difficult to reconcile, and in particular good resistance to ozone, low hysteresis and a stiffness suited to the outer sidewalls for tyres.

In particular, ozone is known to have adverse effects on rubber articles, typically producing a glazing and/or cracks at the surface of these articles. In order to combat these adverse effects, use is conventionally made of anti-ozone waxes well known to those skilled in the art. However, when exposure to ozone is particularly high, the use of anti-ozone wax may not prove sufficient.

There is therefore also a need to minimize these phenomena, in particular without being detrimental to the other properties of the outer sidewall.

Continuing its research, the applicant has developed a rubber composition for the outer sidewall of a tyre giving said outer sidewall improved resistance to ozone compared to the outer sidewalls of the prior art, and also good mechanical properties, in particular elongation at break which is synonymous with resistance to impacts or physical attacks such as impacts from the pavement, using a specific rubber composition comprising in particular a specific blend of elastomer and a salt of an alkali, alkaline-earth or lanthanide metal.

Thus, a subject of the present invention is in particular a tyre provided with at least one outer sidewall, the at least one outer sidewall comprising, or consisting of, a composition based on:
an elastomeric matrix comprising at least one isoprene elastomer and one polybutadiene,
0.2 to 10 phr of at least one salt of an alkali, alkaline-earth or lanthanide metal,
at least one reinforcing filler, and
a crosslinking system.

In the present document, unless otherwise indicated, when mention is made of “the composition” or “the composition in accordance with the invention”, reference is made to the composition of the at least one outer sidewall of the tyre according to the invention.

### I—DEFINITIONS

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

For the purposes of the present invention, the expression “part by weight per hundred parts by weight of elastomer” (or phr) should be understood as meaning the part by weight per hundred parts by weight of elastomer.

In the present document, unless expressly indicated otherwise, all the percentages (%) indicated are weight percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is described by the expression “from a to b”, the interval represented by the expression “between a and b” is also and preferably described.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Thus, for example, a predominant elastomer is the elastomer representing the greatest weight with respect to the total weight of the elastomers in the composition. In the same way, a “predominant” filler is that representing the greatest weight among the fillers of the composition. By way of example, in a system comprising just one elastomer, the latter is predominant for the purposes of the present invention and, in a system comprising two elastomers, the predominant elastomer represents more than half of the weight of the elastomers. Preferably, the term “predominant” is understood to mean present at more than 50%, preferably more than 60%, 70%, 80%, 90%, and more preferentially the “predominant” compound represents 100%.

The compounds comprising carbon mentioned in the description may be of fossil origin or biobased. In the latter case, they may be partially or totally derived from biomass or may be obtained from renewable starting materials derived from biomass. Polymers, plasticizers, fillers, etc. are notably concerned.

The glass transition temperatures (Tg) of the elastomers are determined by means of a differential scanning calorimeter according to standard ASTM E1356-08 (2014).

### II—BRIEF DESCRIPTION OF THE SINGLE FIGURE

FIG. 1 represents very diagrammatically and without being to a specific scale, a radial cross section of a pneumatic tyre in accordance with the invention.

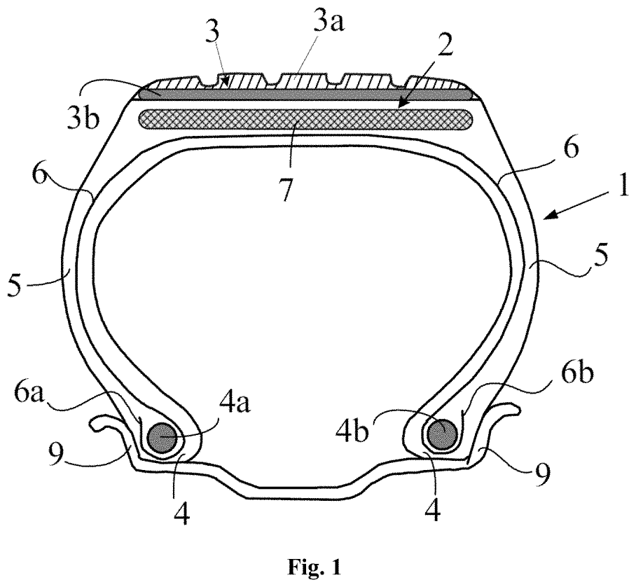

This pneumatic tyre (1) comprises a crown (2) surmounted by a tread (3) (to simplify, comprising a very simple pattern), the radially outer part (3a) of which is intended to come into contact with the ground, two outer sidewalls (5) and two beads (4), each of these beads 4 being reinforced with a bead wire (4a, 4b). A carcass reinforcement (6) is wound around the two bead wires (4a, 4b) in each bead (4), the upturn (6a, 6b) of this reinforcement (6) being for example disposed towards the outside of the tyre (1) which is shown here mounted on its rim (9). The carcass reinforcement (6) can be, in a manner known per se, formed of at least one ply reinforced with “radial” cords, for example made of textile or metal, that is to say that these cords are positioned virtually parallel to each other and extend from one bead to the other so as to form an angle of between 80° and 90° with the median circumferential plane (plane perpendicular to the axis of rotation of the tyre which is located midway between the two beads (4) and passes through the middle of the tread (3)). The crown (2) is reinforced by a crown reinforcement or belt (7) which is radially external with respect to the carcass reinforcement (6). The crown reinforcement (7) can for example consist of at least two superimposed crossed plies reinforced with metal cables. The tread (3) comprises a radially inner elastomeric layer (3b) which is disposed between the radially outer layer (3a) and the crown reinforcement (7). This layer (3b) can be a tread “underlayer” or simply the radially inner part of the tread (3), it being possible for the layers (3a) and (3b) to consist of one and the same composition or of different compositions. Of course, this tyre (1) additionally comprises, in a known manner, a layer of inner rubber or elastomer (commonly known as “inner liner”) which defines the radially inner face of the tyre and which is intended to protect the carcass ply from the diffusion of air originating from the space interior to the tyre.

### III—DESCRIPTION OF THE INVENTION

### III-1 Elastomeric Matrix

The composition of the at least one outer sidewall of the tyre according to the invention comprises at least one elastomeric matrix comprising an isoprene elastomer and a polybutadiene.

The term “isoprene elastomer” is understood to mean, in a known manner, an isoprene homopolymer or copolymer, in other words a diene elastomer selected from the group consisting of natural rubber (NR), synthetic polyisoprenes (IRs), the various isoprene copolymers and the mixtures of these elastomers. Mention will in particular be made, among isoprene copolymers, of isobutene/isoprene (butyl rubber—IIR), isoprene/styrene (SIR), isoprene/butadiene (BIR) or isoprene/butadiene/styrene (SBIR) copolymers.

Advantageously, the isoprene elastomer is a polyisoprene comprising a weight content of 1,4-cis bonds of at least 90%, preferably at least 98%, of the weight of the polyisoprene.

Preferably, the isoprene elastomer is selected from the group consisting of natural rubber, synthetic polyisoprenes and mixtures thereof. More preferably, the polyisoprene is a natural rubber.

The content of isoprene elastomer in the composition of the at least one outer sidewall of the tyre according to the invention is preferentially within a range extending from 10 to 60 phr, preferably from 30 to 60 phr.

The term “polybutadiene” (abbreviated to “BR”) will be understood to mean that it may be one or more polybutadienes. Polybutadiene is a well-known rubber which is made by polymerizing 1,3-butadiene monomer (typically a homopolymerization) in a solution polymerization process using suitable catalysts known to those skilled in the art. Due to the two double bonds present in the butadiene monomer, the resulting polybutadiene can comprise three different forms: a cis-1,4-polybutadiene, a trans-1,4-polybutadiene and a 1,2-vinylpolybutadiene. The cis-1,4 and trans-1,4 elastomers are formed by the monomers connecting end to end, while the 1,2-vinyl elastomer is formed by the monomers connecting between the ends of the monomer. The choice of catalyst and the temperature of the process are known as the variables generally used to control the content of cis-1,4 bonds in polybutadiene.

Advantageously, the polybutadiene has a content (mol %) of cis-1,4 linkages greater than 90%, more preferentially greater than 95%.

Such polybutadienes can be produced using a neodymium catalyst in a manner well known to those skilled in the art, for example according to a process described in document JP 60/23406 A and WO 03/097708 A1. Such polybutadienes can also be commercially available, for example, Buna® CB 22 marketed by Lanxess.

Advantageously, the glass transition temperature of the polybutadiene is within a range extending from −110° C. to −80° C., preferably from −108° C. to −100° C.

The content of polybutadiene in the composition of the at least one outer sidewall of the tyre according to the invention is preferentially within a range extending from 40 to 90 phr, preferably from 40 to 70 phr.

Thus, according to the invention, the elastomeric matrix of the at least one outer sidewall advantageously comprises from 10 to 60 phr of isoprene elastomer and from 40 to 90 phr of polybutadiene, preferably from 30 to 60 phr of isoprene elastomer and from 40 to 70 phr of polybutadiene.

The composition of the at least one outer sidewall of the tyre according to the invention may comprise another diene elastomer, different from the isoprene elastomer and from polybutadiene (hereinafter referred to as “other diene elastomer”), but this is not preferable.

The term “diene” elastomer (or, without distinction, rubber), whether natural or synthetic, should be understood, in a known manner, as meaning an elastomer composed, at least in part (i.e., a homopolymer or a copolymer), of diene monomer units (monomers bearing two conjugated or non-conjugated carbon-carbon double bonds).

These diene elastomers may be classified into two categories: “essentially unsaturated” or “essentially saturated”. The term “essentially unsaturated” generally refers to a diene elastomer at least partly derived from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and may notably be described as “essentially saturated” diene elastomers (low or very low content, always less than 15%, of units of diene origin).

Advantageously, the other diene elastomer is an essentially unsaturated diene elastomer.

The term “diene elastomer that may be used in the compositions in accordance with the invention” particularly means:
a) any homopolymer of a conjugated or non-conjugated diene monomer having from 4 to 18 carbon atoms;
b) any copolymer of a conjugated or non-conjugated diene having from 4 to 18 carbon atoms and of at least one other monomer.

The other monomer may be ethylene, an olefin or a conjugated or non-conjugated diene.

Conjugated dienes that are suitable include conjugated dienes having from 4 to 12 carbon atoms, in particular 1,3-dienes.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl)styrene.

Suitable as aliphatic α-monoolefins are in particular acyclic aliphatic α-monoolefins having from 3 to 18 carbon atoms.

Preferentially, the other diene elastomer is selected from butadiene copolymers. The butadiene copolymers are preferentially selected from the group consisting of butadiene/styrene copolymers (SBRs).

It will be noted that the SBR may be prepared in emulsion (ESBR) or in solution (SSBR). Whether it is ESBR or SSBR. Mention may in particular be made, among copolymers based on styrene and butadiene, in particular SBR, of those having a styrene content of between 5% and 60% by weight and more particularly between 20% and 50%, a content (mol %) of 1,2-bonds of the butadiene part of between 4% and 75%, and a content (mol %) of trans-1,4-bonds of between 10% and 80%.

Advantageously, the total content of isoprene elastomer and of polybutadiene, in the composition of the at least one outer sidewall of the tyre according to the invention, is advantageously within a range extending from 80 to 100 phr, preferably from 90 to 100 phr; preferably, the total content of isoprene elastomer and of polybutadiene, in the composition of the at least one outer sidewall of the tyre according to the invention, is 100 phr.

Thus, the content of the other diene elastomer, in the composition of the at least one outer sidewall of the tyre according to the invention, is at most 20 phr, preferably less than or equal to 10 phr. Preferably, the composition of the at least one outer sidewall of the tyre according to the invention does not comprise any elastomer other than isoprene elastomers and polybutadienes.

The composition of the at least one outer sidewall of the tyre according to the invention can also contain, as a minority, any type of synthetic elastomer other than a diene elastomer, or even with polymers other than elastomers, for example thermoplastic polymers, but this is not preferable. Preferably, the composition of the at least one outer sidewall of the tyre according to the invention does not contain a synthetic elastomer other than a diene elastomer or a polymer other than elastomers or contains less than 10 phr, preferably less than 5 phr, thereof.

### III-2 Salt of an Alkali, Alkaline-Earth or Lanthanide Metal

The composition of the at least one outer sidewall of the tyre according to the invention comprises from 0.2 to 10 phr of at least one salt of an alkali, alkaline-earth or lanthanide metal.

The salt of an alkali, alkaline-earth or lanthanide metal is advantageously an acetylacetonate of an alkali, alkaline-earth or lanthanide metal.

Preferably, the alkali, alkaline-earth or lanthanide metal of the salt is selected from the group consisting of lithium, sodium, potassium, calcium, magnesium, lanthanum, cerium, praseodymium, neodymium, samarium, erbium and mixtures thereof. More preferably, the salt of an alkali, alkaline-earth or lanthanide metal is a magnesium or neodymium salt, preferably a magnesium salt. In other words, the salt of an alkali, alkaline-earth or lanthanide metal is advantageously a magnesium or neodymium acetylacetonate, preferably a magnesium acetylacetonate.

The content of the at least one salt of an alkali, alkaline-earth or lanthanide metal, in the composition of the at least one outer sidewall of the tyre according to the invention, can be for example within a range extending from 0.2 to 10 phr, preferably 0.5 to 5 phr, preferably 1 to 4 phr.

Advantageously, the total content of salt of an alkali, alkaline-earth or lanthanide metal, in the composition of the at least one outer sidewall of the tyre according to the invention, is within a range extending from 0.2 to 10 phr, preferably 0.5 to 5 phr, preferably 1 to 4 phr.

Such compounds are well known for other applications (see for example WO 95/03348 and WO 96/03455).

By way of example of commercially available compounds, mention may be made of “NACEM Magnesium” magnesium acetylacetonate (CAS 68488-07-3) from Niho Kagaku Sangyo.

### III-3 Reinforcing Filler

The composition of the at least one outer sidewall of the tyre according to the invention additionally comprises a reinforcing filler, known for its abilities to reinforce a rubber composition that can be used for the manufacture of tyres.

The reinforcing filler can comprise carbon black and/or silica. Advantageously, the reinforcing filler predominantly, preferably exclusively, comprises carbon black.

The blacks that can be used in the context of the present invention can be any black conventionally used in tyres or their treads (“tyre-grade” blacks). Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated in the diene elastomer, in particular isoprene elastomer, in the form of a masterbatch (see, for example, applications WO 97/36724 or WO 99/16600).

Mention may be made, as examples of organic fillers other than carbon blacks, of functionalized polyvinyl organic fillers, such as described in applications WO 2006/069792, WO 2006/069793, WO 2008/003434 and WO 2008/003435.

Advantageously, the carbon black predominantly, preferably exclusively, comprises a carbon black having a BET specific surface area of less than 100 m²/g, preferably within a range extending between 30 and 100 m²/g, preferably between 40 and 80 m²/g, preferably between 40 and 70 m²/g.

The BET specific surface area of the carbon blacks is measured according to standard ASTM D6556-10 [multipoint (a minimum of 5 points) method—gas: nitrogen—relative pressure P/PO range: 0.1 to 0.3].

If silica is used in the at least one outer sidewall of the tyre according to the invention, it can be any silica known to those skilled in the art, in particular any precipitated or fumed silica exhibiting a BET specific surface area and a CTAB specific surface area which are both less than 450 m²/g, preferably from 30 to 400 m²/g.

The BET specific surface area of the silica is determined by gas adsorption using the Brunauer-Emmett-Teller method described in “The Journal of the American Chemical Society”, (Vol. 60, page 309, February 1938), and more specifically according to a method derived from standard NF ISO 5794-1, Appendix E, of June 2010 [multipoint (5 point) volumetric method—gas: nitrogen —degassing under vacuum: one hour at 160° C.—relative pressure range p/po: 0.05 to 0.17].

The CTAB specific surface area values of the silica were determined according to standard NF ISO 5794-1, Appendix G of June 2010. The process is based on the adsorption of CTAB (N-hexadecyl-N,N,N-trimethylammonium bromide) on the “external” surface of the reinforcing filler.

Preferably, if silica is used in the at least one outer sidewall of the tyre according to the invention, the silica has a BET specific surface area of less than 200 m²/g and/or a CTAB specific surface area is less than 220 m²/g, preferably a BET specific surface area within a range extending from 125 to 200 m²/g and/or a CTAB specific surface area within a range extending from 140 to 170 m²/g.

Mention will be made, as silicas that can be used in the context of the present invention, for example, of the highly dispersible precipitated silicas (termed “HDSs”) Ultrasil 7000 and Ultrasil 7005 from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

In order to couple the reinforcing silica to the diene elastomer, use may be made, in a well-known manner, of an at least bifunctional coupling agent (or bonding agent) intended to provide a satisfactory connection, of chemical and/or physical nature, between the silica (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound can comprise a first functional group comprising a silicon atom, said first functional group being able to interact with the hydroxyl groups of an inorganic filler and a second functional group comprising a sulfur atom, said second functional group being able to interact with the diene elastomer.

Preferably, the organosilanes are selected from the group consisting of organosilane polysulfides (symmetrical or asymmetrical) such as bis(3-triethoxysilylpropyl) tetrasulfide, abbreviated to TESPT sold under the name “Si69” by Evonik or bis(triethoxysilylpropyl)disulfide, abbreviated to TESPD sold under the name “Si75” by Evonik, polyorganosiloxanes, mercaptosilanes, blocked mercaptosilanes, such as S-(3-(triethoxysilyl)propyl) octanethioate sold by Momentive under the name “NXT Silane”. More preferentially, the organosilane is an organosilane polysulfide. Of course, use might also be made of mixtures of the coupling agents described above.

Those skilled in the art can find coupling agent examples in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

The content of reinforcing filler, preferably carbon black, in the composition of the at least one outer sidewall of the tyre according to the invention, is preferably within a range extending from 5 to 70 phr, preferably from 10 to 65 phr, more preferably from 15 to 60 phr.

If silica is used in the at least one outer sidewall of the tyre according to the invention, it may be present, for example, in an amount ranging from 5 to 60 phr, preferably from 10 to 55 phr. Furthermore, the content of coupling agent, in the composition of the at least one outer sidewall of the tyre according to the invention, advantageously represents from 0.5% to 15% by weight relative to the weight of silica, preferably from 5% to 12%, preferably from 7% to 11% by weight relative to the weight of silica. Those skilled in the art can easily adjust the content of coupling agent according to the content of silica used in the composition of the at least one outer sidewall of the tyre according to the invention.

### III-4 Crosslinking System

The system for crosslinking the composition of the at least one outer sidewall of the tyre according to the invention can be based on molecular sulfur and/or on sulfur donors and/or on peroxide, which are well known to those skilled in the art.

The crosslinking system is preferentially a vulcanization system based on sulfur (molecular sulfur and/or sulfur-donating agent).

Whether it comes from molecular sulfur or from the sulfur-donating agent, the sulfur in the composition of the at least one outer sidewall of the tyre according to the invention is used at a preferential content of between 0.5 and 10 phr. Advantageously, the sulfur content in the composition of the at least one outer sidewall of the tyre according to the invention is between 0.5 and 2 phr, preferably between 0.6 and 1.5 phr.

The composition of the at least one outer sidewall of the tyre according to the invention advantageously comprises a vulcanization accelerator, which is preferably selected from the group consisting of accelerators of the type of thiazoles and their derivatives, accelerators of the types of sulfenamides and thioureas and of mixtures thereof. Advantageously, the vulcanization accelerator is selected from the group consisting of 2-mercaptobenzothiazyl disulfide (MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), morpholine disulfide, N-morpholino-2-benzothiazolesulfenamide (MBS), dibutylthiourea (DBTU) and of mixtures thereof. Particularly preferably, the primary vulcanization accelerator is N-cyclohexyl-2-benzothiazolesulfenamide (CBS).

The content of vulcanization accelerator in the composition of the at least one outer sidewall of the tyre according to the invention is preferentially within a range extending from 0.2 to 10 phr, preferably from 0.5 to 2 phr, preferably between 0.5 and 1.5 phr, more preferably between 0.5 and 1.4 phr.

Advantageously, the sulfur or sulfur donor/vulcanization accelerator weight ratio, in the composition of the at least one outer sidewall of the tyre according to the invention, is within a range extending from 1.2 to 2.5, preferably from 1.5 to 2.

### III-5 Other Possible Additives

The rubber compositions of the at least one outer sidewall of the tyre according to the invention may optionally also comprise all or some of the usual additives customarily used in elastomer compositions for tyres, such as for example plasticizers (such as plasticizing oils and/or plasticizing resins), pigments, protective agents such as anti-ozone waxes, chemical anti-ozonants, antioxidants, anti-fatigue agents, reinforcing resins (as described for example in application WO 02/10269).

In particular, the composition of the at least one outer sidewall of the tyre according to the invention can comprise an extender oil (or plasticizing oil) which is liquid at 20° C., referred to as “low Tg”, that is to say which by definition has a Tg of less than −20° C., preferably less than −40° C. The glass transition temperature Tg is measured, in a known manner, by DSC (Differential Scanning calorimetry), according to standard ASTM D3418 (1999).

Any extender oil, whether it is of aromatic or non-aromatic nature, known for its plasticizing properties with regard to elastomers can be used. At ambient temperature (20° C.), these oils, which are more or less viscous, are liquids (that is to say, as a reminder, substances which have the ability to eventually assume the shape of their container), unlike in particular hydrocarbon resins with a high Tg, which are by nature solids at ambient temperature.

Plasticizing oils selected from the group consisting of naphthenic oils (low- or high-viscosity, in particular hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, plant oils, ether plasticizers, ester plasticizers, phosphate plasticizers, sulfonate plasticizers and the mixtures of these compounds are particularly suitable.

Advantageously, the composition of the at least one outer sidewall of the tyre according to the invention does not comprise any plasticizing oil or comprises less than 30 phr thereof, preferably less than 25 phr thereof, more preferably less than 10 phr thereof.

### III-6 Tyre

The tyre according to the invention can be a tyre as described in point II above in which at least one outer sidewall comprises a composition in accordance with the invention.

In particular, the tyre according to the invention advantageously comprises:
a crown (2) surmounted by a tread (3);
two non-stretchable beads (4), two outer sidewalls (5) connecting the beads (4) to the tread (3), a carcass reinforcement (6) passing into the two outer sidewalls (5) and anchored in the beads (4);
the crown (2) being reinforced by a crown reinforcement or belt (7) positioned circumferentially between the carcass reinforcement (6) and the tread (3).

Preferably, in the tyre according to the invention, the two outer sidewalls comprise, or consist of, a composition in accordance with the invention, it being possible for the compositions of the two outer sidewalls to be identical or different (while being in accordance with the invention). Preferably, the compositions of the two outer sidewalls are identical.

The present invention can be applied to any type of tyre. The tyre according to the invention may be intended to equip motor vehicles of passenger vehicle type, SUVs (“Sport Utility Vehicles”), or two-wheel vehicles (in particular motorcycles), or aircraft, or also industrial vehicles selected from vans, heavy-duty vehicles—that is to say, underground trains, buses, heavy road transport vehicles (lorries, tractors, trailers) or off-road vehicles, such as heavy agricultural vehicles or earthmoving equipment—, and others.

The invention relates to tyres both in the raw state (that is to say, before curing) and in the cured state (that is to say, after crosslinking or vulcanization).

### III-7 Preparation of the Rubber Compositions

The composition of the at least one outer sidewall of the tyre according to the invention can be manufactured in suitable mixers, using two successive preparation phases well known to those skilled in the art:
a first phase of thermomechanical working or kneading (“non-productive” phase), which can be carried out in a single thermomechanical step during which all the necessary constituents, in particular the elastomeric matrix, the reinforcing filler and the optional other various additives, with the exception of the crosslinking system, are introduced into an appropriate mixer, such as a standard internal mixer (for example of ‘Banbury’ type). The incorporation of the optional filler into the elastomer may be performed in one or more portions while thermomechanically kneading. In the case where the filler is already incorporated, in full or in part, in the elastomer in the form of a masterbatch, as is described, for example, in applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases have been described, for example, in applications EP-A-0501227, EP-A-0735088, EP-A-0810258, WO 00/05300 or WO 00/05301.

The final composition thus obtained is then calendered, for example in the form of a sheet or of a slab, in particular for characterization in the laboratory, or else extruded (or co-extruded with another rubber composition) in the form of a semi-finished (or profiled) element of rubber that can be used, for example, as a tyre outer sidewall. These products can subsequently be used for the manufacture of tyres, according to techniques known to those skilled in the art.

The crosslinking of the composition can be carried out in a manner known to those skilled in the art, for example at a temperature of between 130° C. and 200° C., under pressure.

### IV—EXAMPLES

### IV-1 Measurements and Tests Used

### Ozone Resistance:

The ozone resistance measurements were carried out according to the ASTM D1149-18 standard on test specimens. The test specimens were subjected to an ozone concentration of 40 pphm (parts per hundred million), at a temperature of 10° C., for a period ranging up to 8 days, and to various static extensions of between 5% and 50% with a step of 5%.

The test specimens result from an MFTR (known as Monsanto) plate, the two beads of which located at the ends are used to hold the test specimen. Their dimensions are as follows: 75 mm×20 mm×2.5 mm.

The appearance of the test specimens was noted at a given time after exposure to the various elongations. The scores are between 0 (no degradation observed) and 4 (most degraded appearance). When the test specimens are ruptured, the representation is denoted R.

### Elongation at Break:

The elongation at break (% EB) tests are based on standard NF ISO 37 of December 2005 on a type H2 dumbbell specimen under normal conditions of temperature (23±2° C.) and hygrometry (50±5% relative humidity), according to French standard NF T 40-101 (December 1979). The measurements are carried out at a pull speed of 500 mm/min. The elongation at break is expressed as a percentage of elongation.

The results are expressed in base 100, the value 100 being assigned to the control. A result greater than 100 indicates that the composition of the example under consideration has a greater resistance to elongation, reflecting better mechanical properties of the composition under consideration.

### IV-2 Preparation of the Compositions

In the examples which follow, the rubber compositions were produced as described in point 111.7 above. In particular, the “non-productive” phase was carried out in a 5 litre mixer for 3.5 minutes, for a mean blade speed of 50 revolutions per minute, until a maximum dropping temperature of 165° C. was reached. The “productive” phase was carried out in an open mill at 23° C. for 5 minutes.

### IV-3 Tests on Rubber Compositions

The objective of the examples presented below is to compare the ozone resistance of a control composition T, not comprising a salt of an alkali, alkaline-earth or lanthanide metal, with two compositions in accordance with the invention C1 and C2, comprising a salt of an alkali, alkaline-earth or lanthanide metal at 2 or 4 phr. The formulations tested (in phr) are presented in Table 1 below.

TABLE 1

| | T | C1 | C2 |
|---|---|---|---|
| NR (1) | 50 | 50 | 50 |
| BR (2) | 50 | 50 | 50 |
| Oil (3) | 20 | 20 | 20 |
| N683 (4) | 49 | 49 | 49 |
| Mg Salt (5) | — | 2 | 4 |
| Sulfur | 1.4 | 1.4 | 1.4 |
| Accelerator (6) | 1.4 | 1.4 | 1.4 |
| Stearic acid (7) | 2.5 | 2.5 | 2.5 |
| ZnO (8) | 3 | 3 | 3 |
| Antioxidant (9) | 1.5 | 1.5 | 1.5 |
| Anti-ozone wax (10) | 1 | 1 | 1 |

(1) Natural rubber
(2) Polybutadiene, 98% (mol) 1,4-cis− - Tg = −108° C.
(3) MES oil, Catenex SNR, sold by Shell
(4) Carbon black of N683 grade according to standard ASTM D-1765
(5) Magnesium acetylacetonate, NACEM Magnesium, from Niho Kagaku Sangyo
(6) N-Cyclohexyl-2-benzothiazolesulfenamide, Santocure CBS from Flexsys
(7) “Pristerene 4931” stearic acid from Uniqema
(8) Zinc oxide (industrial grade - Umicore)
(9) N-(1,3-Dimethylbutyl)-N-phenyl-para-phenylenediamine (Santoflex 6-PPD from Flexsys)
(10) Anti-ozone wax, Varazon 4959 from Sasol Wax

The ozone resistance results at various elongations (%) and after various exposure periods (hours) are shown in Table 2 below.

TABLE 2

| Ozone resistance | T | C1 | C2 |
|---|---|---|---|
| 120 h at 40% | R | 4 | 4 |
| 48 h at 60% | 4 | 3 | 3 |

These results show that the addition of a salt of an alkali, alkaline-earth or lanthanide metal to the composition makes it possible to reduce the appearance of cracking. The compositions in accordance with the invention thus exhibit improved ozone resistance.

Other experiments were carried out in order to measure the impact of the nature of the elastomer blend on the mechanical properties of the compositions. The new Control formulations (T1 and T2) differ from the formulations in accordance with the invention (C1 and C2) only in that the polybutadiene of compositions C1 and C2 has been replaced with a butadiene-styrene copolymer. The formulations tested (in phr) and the results obtained are presented in Table 3 below.

TABLE 3

| | T | C1 | C2 | T1 | T2 |
|---|---|---|---|---|---|
| NR (1) | 50 | 50 | 50 | 50 | 50 |
| BR (2) | 50 | 50 | 50 | — | — |
| SBR (11) | — | — | — | 50 | 50 |
| Oil (3) | 20 | 20 | 20 | 20 | 20 |
| N683 (4) | 49 | 49 | 49 | 49 | 49 |
| Mg Salt (5) | — | 2 | 4 | 2 | 4 |
| Sulfur | 1.4 | 1.4 | 1.4 | 1.4 | 1.4 |
| Accelerator (6) | 1.4 | 1.4 | 1.4 | 1.4 | 1.4 |
| Stearic acid (7) | 2.5 | 2.5 | 2.5 | 2.5 | 2.5 |
| ZnO (8) | 3 | 3 | 3 | 3 | 3 |
| Antioxidant (9) | 1.5 | 1.5 | 1.5 | 1.5 | 1.5 |
| Anti-ozone wax (10) | 1 | 1 | 1 | 1 | 1 |
| % EB | 100 | 193 | 191 | 182 | 163 |

(1) to (10) see Table 1 above
(11) SBR solution functionalized with 3-Tris-ditertiobutylphenyl phosphite, with 24% of 1,2-polybutadiene units - 26.5% of styrene units - Tg = −48° C.

These results show that the specific blend of an isoprene elastomer and of a polybutadiene in the presence of a salt of an alkali, alkaline-earth or lanthanide metal makes it possible to further improve the mechanical properties of the composition compared to an elastomeric blend of an isoprene elastomer and a butadiene-styrene copolymer.

1.-15. (canceled)

16. A tire provided with at least one outer sidewall, the at least one outer sidewall comprising a composition based on:
an elastomeric matrix comprising at least one isoprene elastomer and one polybutadiene;
0.2 to 10 phr of at least one salt of an alkali, alkaline-earth or lanthanide metal;
at least one reinforcing filler; and
a crosslinking system.

17. The tire according to claim 16, wherein the elastomeric matrix comprises from 10 to 60 phr of isoprene elastomer and from 40 to 90 phr of polybutadiene.

18. The tire according to claim 16, wherein the at least one isoprene elastomer is selected from the group consisting of natural rubber, synthetic polyisoprenes and mixtures thereof.

19. The tire according to claim 16, wherein a total content of isoprene elastomer and of polybutadiene in the composition is within a range extending from 80 to 100 phr.

20. The tire according to claim 16, wherein the polybutadiene has a glass transition temperature within a range extending from −110° C. to −80° C.

21. The tire according to claim 16, wherein the salt of an alkaline-earth, alkali or lanthanide metal is an acetylacetonate of an alkaline-earth, alkali or lanthanide metal.

22. The tire according to claim 16, wherein the alkaline-earth, alkali or lanthanide metal of the salt is selected from the group consisting of lithium, sodium, potassium, calcium, magnesium, lanthanum, cerium, praseodymium, neodymium, samarium, erbium and mixtures thereof.

23. The tire according to claim 16, wherein the salt of an alkaline-earth, alkali or lanthanide metal is a magnesium or neodymium acetylacetonate.

24. The tire according to claim 16, wherein a content of the salt of an alkaline-earth, alkali or lanthanide metal in the composition is within a range extending from 0.5 to 5 phr.

25. The tire according to claim 16, wherein the reinforcing filler comprises carbon black, silica or both carbon black and silica.

26. The tire according to claim 16, wherein the reinforcing filler predominantly comprises carbon black.

27. The tire according to claim 25, wherein the carbon black has a BET specific surface area of between 30 and 100 m²/g.

28. The tire according to claim 16, wherein a content of reinforcing filler is within a range extending from 5 to 70 phr.

29. The tire according to claim 16, wherein the crosslinking system is based on molecular sulfur, on a sulfur-donating agent, or on both molecular sulfur and a sulfur-donating agent.

30. The tire according to claim 29, wherein a sulfur content in the composition is between 0.5 and 2 phr.
